(19) United States
(12) Patent Application Publication
(10) Pub. No.: US 2008/0154626 A1
(43) Pub. Date: Jun. 26, 2008

(54) AGGREGATING AND SHARING TRUST-OWNED MEDIA

(75) Inventors: Alexander Gounares, Kirkland, WA (US); Gary W. Flake, Bellevue, WA (US); Lili Cheng, Bellevue, WA (US); Jeffrey R. Hemmen, Renton, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/960,419

(22) Filed: Dec. 19, 2007

Related U.S. Application Data
(60) Provisional application No. 60/870,926, filed on Dec. 20, 2006.

(51) Int. Cl. G06Q 30/00

(52) U.S. Cl. 705/1

(57) ABSTRACT

Aggregating ownership of certain types of intellectual property and providing withdrawal privileges based at least in part on individual contribution to the common ownership is described herein. Particularly, electronic media can be received, parsed, aggregated with other media, and stored as a superset of media. The superset can be owned commonly by those who submitted media to the trust based in part on a number, type, value, and/or demand, or the like, of submitted media. Further, participants can withdraw media items from the trust based in part on submission of media to the trust. Accordingly, individuals can aggregate collections of digital media and share such media in a manner that complies with DRM restrictions and intellectual property rights of associated entities.

### PRIORITY CLAIM TO RELATED APPLICATION

The present application for patent claims priority to Provisional Application No. 60/870,926 entitled DISTRIBUTED ARCHITECTURES FOR SEARCH AND ADVERTISING and filed Dec. 20, 2006, assigned to the assignee hereof and expressly incorporated by reference herein.

### BACKGROUND

Copies of digital media are typically purchased by consumers along with a right to playback such copies for personal and like uses. The copy can be stored on a hardcopy storage device, such as a digital video disc (DVD), compact disc (CD), cassette tape or other tape-recorded media, or the like, or an electronic software copy such as an mp3 file, a Windows Media Player file, and so on, downloaded to a computing device via a remote network. Trading and resale of hardcopy media is a common social and commercial activity, providing further consumer exposure to the media and sometimes an opportunity to recoup an initial investment in such media.

There are certain types of digital media, especially that obtained for educational or entertainment value, for which the value of possession diminishes over time. For instance, many individuals have a collection of console game, computer software, exam preparation and/or coursework materials, video titles, music titles, or the like, that see little or no use after an initial period of utility. After-sale businesses exist that might pay a small amount for used hardcopies of such items, but often consumers feel that the amount is not worth the time required to transact such business. Instead, individual collections often just take up space until they are eventually discarded. Recently many consumers have turned from hardcopy media to software media, due to the large storage capacity of digital storage devices, and ability to collect large numbers of media on a relatively unobtrusive hard disc. However, sharing, trading and resale of softcopies can be troublesome, as it can be difficult to ensure that copyright laws are followed when doing so.

Because of the ease and accuracy with which digital media can be reproduced, much debate has occurred in recent years surrounding consumer resale and sharing rights associated with copies of digital media. Although network-based media sharing initiatives such as Napster, Lime-Wire and the like have made sharing digital media over the Internet easy, such initiatives can often lead to violation of copyright laws of participants are not mindful of their activity. Accordingly, software copies of media have also begun to collect e-dust, colloquially speaking, as consumers turn away from trading electronic copies to avoid infringing copyright laws. Alternative methods for reselling and/or redistributing hard or soft copies of digital media could be beneficial for such consumers.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject disclosure provides for a virtual trust of commonly owned digital media. The trust can receive physical and/or electronic copies of such media from participants of the trust. The participants transfer ownership rights of submitted media copies in return for access to a portion of the media owned by the trust, based at least in part upon a number and type of copies submitted. The trust can aggregate and store multiple sets of electronic media submitted by a plurality of participants and create a superset of media. The superset can be compiled and catalogued for review by participants. The trust maintains a record of each media element within the superset, and a status indication pertaining to each media element (e.g., movie title, song title, e-Book, video game, and so on). The status indication identifies at least a title of each media element, number of copies within the superset, and whether each copy has been submitted to a participant or is available for request. Only a single participant can possess a single copy of a media element at a given point in time, whether the copy is a hardware copy (e.g., DVD or CD) or a software copy (e.g., mp3 file).

According to further example aspects, the subject disclosure provides for access and possession rights of trust-owned media to a participant of the trust based at least in part on what the participant submitted to the trust. A set of electronic media can be parsed to determine a number of media elements contained within the set, a type of each element (e.g., movie, game, song), or the like. The parse can establish an input participation factor and assign such factor to the participant submitting the set of electronic media. The input participation factor can form a basis for determining a number, type, and/or the like, of media items in the trust that can be withdrawn concurrently by the participant. In addition, a number, type, etc., of such items withdrawn by the participant can be parsed and can form a basis for a media expenditure factor assigned to the participant. If the media expenditure factor reaches a threshold value the participant will be restricted from withdrawing additional media elements from the trust.

According to one or more additional embodiments, a distribution component can be incorporated into a media trust allocation system to output media elements associated with an approved request to trust participants. The distribution component can include, for instance, a communication network that enables participants to interface with an electronic catalogue of a superset of media. Participants can place a request for a media element electronically via the network. An electronic copy of a media element can be submitted to the requester also via the network upon approval of such request. In addition, requested hardware copies can be extracted from a hardware storage associated with the trust and delivered to a requester (e.g., by mail, package delivery service, etc.) upon approval of such request. Once a copy is submitted to a participant of the trust an available number of copies of the media element within the superset can be decremented by one. A submitted electronic copy can be deleted from a trust data store, or can be encrypted to prevent un-permitted access until another electronic copy of the media element is submitted or re-submitted back to the trust data store.

According to further example embodiments, disclosed is a software application that can be utilized to interface with software media elements and incorporate digital rights management (DRM) for software media copies. The application can be provided to participants of a media trust and installed on a remote client device (e.g., a personal computer, DVD player, mp3 player, smart-phone, and so on). A communication network that provides access to trust-owned electronic copies can require the application to submit a proper digital signature in order to withdraw an electronic copy of media. The application can provide a secure interface to the network and a rules server that applies security and request/withdrawal rules for participants, and receive and store electronic copies of media output by the network on the remote client device. Furthermore, the application can secure the stored local copy to prevent unlawful reproduction of the media. According to some embodiments, after a withdrawal period, if any, expires, the application can automatically re-submit the electronic copy to the trust network and/or delete the copy from the client device. Accordingly, the application can also return trust-owned electronic copies of media from a client device back to a trust data store.

In accordance with one or more additional aspects, participants of the trust can provide a rating and/or description of media elements. The ratings/descriptions of multiple participants can be aggregated into a social-based ranking for various media elements. Participants can view the ranks provided by other participants when viewing media owned by the trust. In addition, the trust can provide recommended titles to participants based on prior ratings/descriptions, participation history and participation histories of other participants, and so on. According to some example embodiments, the trust can establish a demand factor for each media element based on a number of requests for the element, a social ranking for the element, withdrawal rate of the item, and so on. Additionally, approval of a request for a media element can be based at least in part on the demand factor.

In addition to the foregoing, external vendors can purchase a right to include advertisement with elements of the media trust. For instance, an entity can submit an electronic version of an advertisement, and the version can be incorporated within an electronic and/or hardware copy of a media element. When a participant plays the media element, the advertisement can be played prior to, after, or contemporaneously with the media. A value can be provided to external entities by exposure of advertisements to participants of the trust that view the media. The trust can charge such entities, as suitable and in compliance with copyrights of the various media elements, upon including the advertisement with a media element, upon submission of such media element to a participant, or the like.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a sample system that can receive and aggregate electronic media into a media trust and output selected files to participants.

FIG. 2 depicts a block diagram of a sample media allocation component that outputs requested media elements to participants of the trust according to aspects.

FIG. 3 illustrates a block diagram of an example system that distributes media output from the trust to participants of the trust according to further aspects.

FIG. 4 depicts a block diagram of a sample client application that can receive, secure, playback and/or return electronic media from the trust.

FIG. 5 depicts a block diagram of a sample system that provides an interface between a participant and media within the trust.

FIG. 6 illustrates a block diagram of an example system that can provide recommended media elements to participants based on prior history and social networking.

FIG. 7 illustrates a block diagram of a sample system that incorporates advertisement of external entities with distributed media in accord with some aspects.

FIG. 8 depicts a block diagram of an example system that filters advertisement from media based on requester status according to additional aspects.

FIG. 9 illustrates a flowchart of a sample methodology for providing trust-owned media sharing according to one or more aspects.

FIG. 10 depicts a flowchart of an example methodology for parsing media submitted to the trust and establishing user access rights based on submitted media.

FIG. 11 illustrates a flowchart of a sample methodology for approving withdrawal of media from a superset of commonly owned media according to aspects.

FIG. 12 illustrates a flowchart of an example methodology for establishing ranking of commonly owned media based on a social network of trust participants.

FIG. 13 depicts an example operating system for automating and/or implementing various aspects of a trust-owned media share system.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component can be localized on one computer and/or distributed between two or more computers. As another example, an interface can include I/O components as well as associated processor, application, and/or API components, and can be as simple as a command line or a more complex Integrated Development Environment (IDE).

Aggregating ownership of certain types of intellectual property and providing withdrawal privileges based at least in part on individual contribution to the common ownership is described herein. Particularly, electronic media can be received, parsed, aggregated with other media, and stored as a superset of media. The superset can be owned commonly by those who submitted media to the trust based in part on a number, type, value, and/or demand, or the like, of submitted media. Accordingly, individual collections of media titles can be submitted for common trust ownership so that other persons participating in the trust can view submitted copies. Alternatively, or in addition, a system can receive submitted media and continue to associate a submitter as an owner of the media. Accordingly, such a system can serve as a centralized data store that can receive and maintain personal media collections. Thus, if a personal device is destroyed, media is not lost. As a corollary, the centralized data store can function as an exchange mechanism to transfer media from one device to another.

According to some aspects, a participant can withdraw items from the trust based at least in part on a set of electronic media submitted to the trust by the participant and availability of a desired item. For instance, if a person submits 20 DVD movies to the trust, that person can have withdrawal privileges corresponding to 20 DVD movies, or some fraction thereof, or of a related media type (e.g., music, console game, educational compilation, literary work, and so on). Any suitable type of media that can be recorded onto a digital and/or analogue storage medium can be included in a definition of ‘media’, as used herein. Examples can include movies, songs, photographs, pictures, drawings, literary works such as fiction or non-fiction books, educational works such as textbooks or study guides, or any suitable combination thereof or of the like.

The subject disclosure further provides mechanisms for protecting copyrights of media provided for common trust ownership. For instance, electronic versions of media can be digitally secured to mitigate un-permitted access. Further, hardware versions of media can be stored in a secure manner (e.g., in a secure room of a building) as well. The trust can catalogue a number of available copies of each media item and only approve withdrawal of such media up to a number of available copies submitted to the trust. With hardcopies, an item output from the trust to a participant is naturally decremented from an available number of such hardcopies. If the participant returns the hardcopy, or another participant submits another hardcopy, the available number is incremented. An electronic counter can be maintained for each media item indicating a number of available copies. The counter can be updated with each submission, withdrawal or return of a copy of each media item.

For electronic copies of media items, a stored copy can be submitted to a participant and deleted from a data store. Alternatively, the stored copy can be secured to mitigate un-permitted access, and an electronic number of available copies can be decremented. A management application can permit distribution of electronic copies until the available number reaches zero, in which case no additional copies of the media will be output. If the copy is returned or another electronic copy is submitted, the electronic number can be updated and withdrawal again permitted so long as such number is non-zero in value. According to some embodiments, the trust can require a client application for distribution of electronic copies. The client application can receive, playback, secure and/or return and delete electronic copies of media in accord with DRM requirements. Accordingly, the subject disclosure provides a mechanism to share digital media in a manner that complies with copyrights, if applicable, of such media.

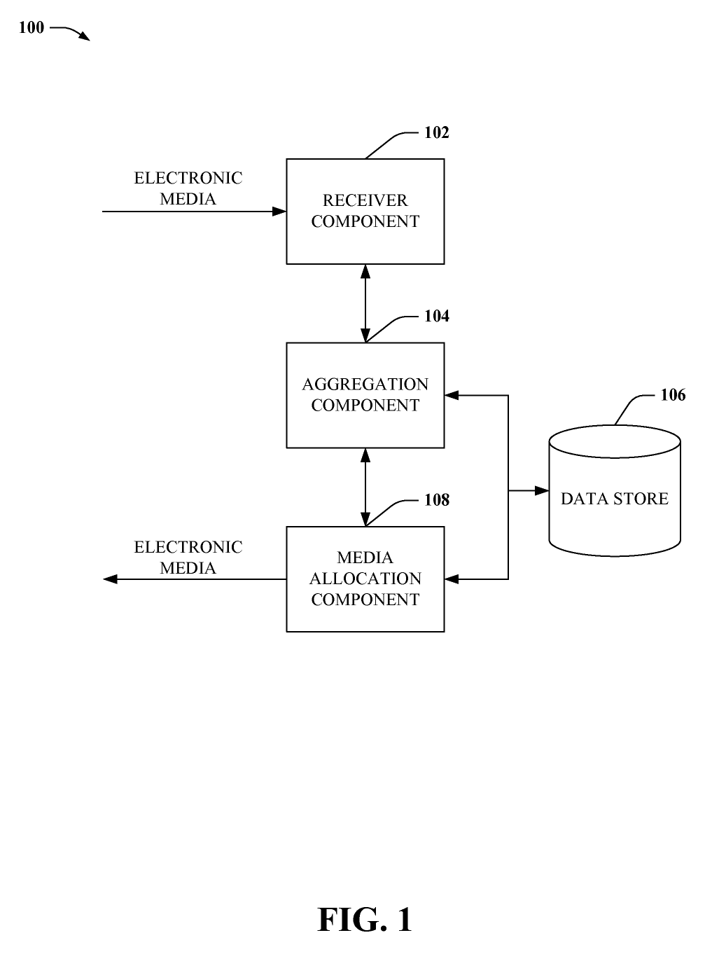

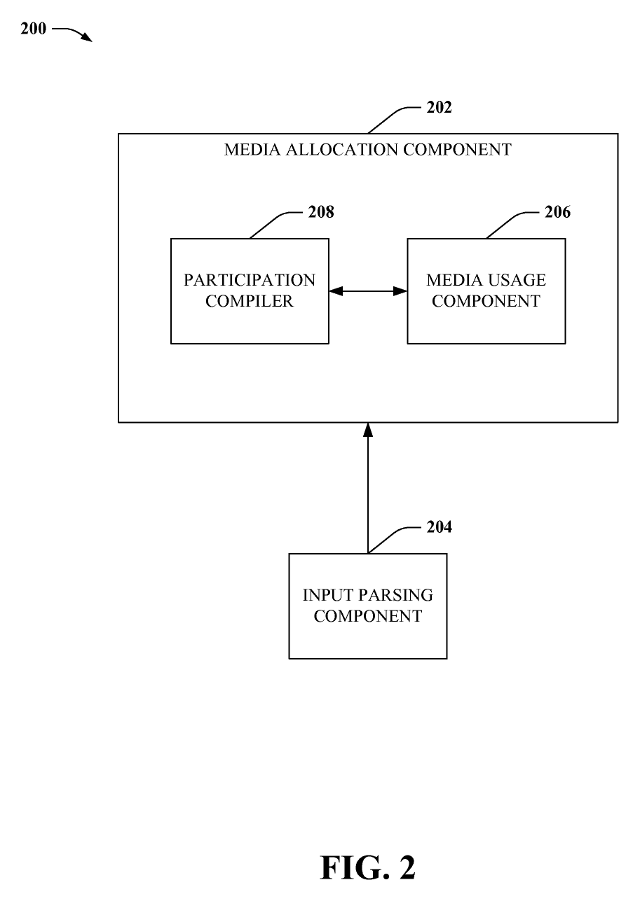

Referring to FIG. 1, a block diagram of an example system 100 that can receive, aggregate and output digital media is depicted. System 100 can receive a set of electronic media at a receiver component 102. The set of electronic media can be parsed to determine number, type or the like of various media elements included within the set (e.g., see FIG. 2), as well as an ID of an entity submitting the set. For instance, a submitted set of electronic media could be determined to include 20 digital video disc (DVD) movies, 100 compact audio discs (CDs), 10 console video games, 20 e-Books, and 200 mp3 song files, or any suitable combination thereof or of like media elements (e.g., movie, song, video game, e-Book, educational and/or exam preparation material, literary work, photograph, and so on).

A submitted set of electronic media can include hardcopies of such media (e.g., a physical DVD) and/or electronic copies of such media (e.g., an mp3 file). Hardcopies can be received by various suitable mechanisms for receiving physical packages, including a drop box, submission center, post office box, and so on. Electronic copies can be received by various suitable mechanisms for receiving electronic data, such as a networked computer(s), server(s), or the like. As a particular example, receiver component 102 can include one or more electronic servers coupled and addressed with the Internet. A participant can upload digital media files (e.g., utilizing a client application incorporating DRM technology, as known in the art, and programmed to interface with the receiver component 102) to such servers to accomplish submitting the set of electronic media. The receiver component can accept or deny the set of electronic media and, if accepted, forward the set or parsed portions thereof to aggregation component 104.

Aggregation component 104 can receive a set of electronic media from receiver component 102, along with an ID associated with an entity submitting the set. The media can be stored in a data store 106 along with other submitted media as a superset of media. The superset can be parsed to identify individual elements of media by title or other suitable unique identifier, a type of each element (e.g., movie, song, mp3 file, video game, literary work, e-Book, educational/exam-prep, etc.), and a number of copies of each element submitted. Media submitted by an entity can be associated with an ID of the entity. The ID can include a username and/or password, electronic signature, electronic certificate, MAC address and/or IP address of a communication device used to submit the set, or like electronic ID, or a name and contact information of a person, or any other suitable factor that can uniquely identify a person, organization, business, corporation etc., submitting media to system 100. Each submitting entity can withdraw available copies of media from the superset based at least in part on the parsed sets submitted by that entity.

Aggregation component 104 can provide a media allocation component 108 with information pertaining at least to number and/or type of media elements associated with a submitting entity. The allocation component 108 can provide such entity access to a subset of a superset of media stored in the data store 106 based on a concurrent participation factor of that entity. Media allocation component 108 can output requested media to a requesting entity if the entity is approved for access to the requested media. For instance, approval can be based on a comparison of the concurrent participation factor and a participation value associated with the requested media (e.g., a single media element can be assigned a value of one, or some fraction thereof). Further, concurrent participation can be compiled based on media submitted to system 100 as well as media output from system 100. As a specific example, if an entity submits ten audio CD titles, the entity could be given an input participation factor of ten (or, e.g., some suitable fraction thereof). If the entity withdraws five audio CDs from the superset, a media expenditure factor associated with the entity can be set to five, and the concurrent participation factor can be adjusted to five (or a fraction thereof). The entity could then be permitted access to any number of media items having a participation value equal or less than five. This might include, for example, either five audio CD titles, five movie titles, five video games, or the like, or a combination of five suitable items.

According to some aspects, a media type can be assigned a participation modifier that adjusts the participation value of the media type with respect to other media types. For instance, a DVD movie could have a participation modifier of 2, and an audio CD could have a participation modifier of 1. Thus, an entity having a concurrent participation factor of 2 could access 1 DVD movie or 2 audio CDs. It should be appreciated that any suitable fraction can be utilized to rank one media element from other media elements, as a function of type of media, demand for a particular item, and so on.

If media allocation component 108 approves access to a media element stored at data store 106, the item is output from the data store 106 to a requesting entity. For instance, electronic copies can be output by way of an electronic connection to a client communication device (e.g., a networked computer). Alternatively, or in addition, hardware copies can be output by removal from a hardware storage facility, deposited with a delivery system, and delivered to a physical address or post office box, or the like, of a requester.

Upon outputting an item to a requesting entity, a media expenditure factor associated with the entity is updated to indicate withdrawal of the item from the commonly owned media trust. For example, if an entity withdraws a single DVD movie from the trust, the expenditure factor can be set to one, or other suitable participation factor associated with drawl of the DVD movie (e.g., determined by media type, popularity or ranking of the item, or the like). The expenditure factor can be subtracted from the entity's input participation factor, resulting in a concurrent participation factor that can be utilized for subsequent requests. If the entity's concurrent participation factor is less than a participation value associated with a requested item, the request can be denied. If the concurrent participation factor reaches zero, the entity can be restricted from withdrawing items from the trust (or, could withdraw the items for a fee, or by subscription, in effect buying the item from the trust) until additional items are submitted to the trust and the entity's input participation factor (and concurrent participation factor) are updated as a result. As described, system 100 provides for receiving and aggregating digital media into a commonly owned trust, and providing withdrawal privileges for a subset of the aggregated media based at least in part upon media submitted to the trust.

FIG. 2 illustrates a block diagram of an example system 200 that includes a media allocation component 202 for outputting media from a commonly owned trust to members of the trust. Individual media items (e.g., DVD movies, audio mp3 files) owned by the trust can be requested by participants. A concurrent participation factor, based at least in part on media the participant has submitted to and/or withdraw from the trust, can be evaluated to approve or deny the request (e.g., as discussed at FIG. 1, supra). If approved, the media can be output to the requesting entity as described herein.

System 200 can include an input parsing component 204 that can receive and/or determine a number of individual media elements contained within a set of electronic media submitted by one or more entities, generate an input participation factor based at least in part on such individual media elements, and assign the factor to such entities. For instance, the parsing component 204 can receive and/or identify a type, title and/or number of media elements. As an example, a received set of electronic media can be examined by parsing component 204. The component (204) can identify, for instance, that the set includes fifteen individual media items. Further, the component (204) can identify a type of the individual media items, for instance, that three are movies, five are audio albums containing a specific number of audio tracks each, three are video games (e.g., Playstation, X-Box, or the like), and four are individual mp3 songs. The parsing component 204 can also determine a title, author, composer, editor, producer, director, actor(s), or a combination thereof or of the like, associated with each media item. For instance, the parsing component 204 can extract such information from portions of the media files themselves, receive the information in conjunction with submission of the set, or search for such information via a search engine connected to a data source (e.g., a data network such as the Internet, a data store 106 associated with the trust, and so on). Any duplicate titles can be identified and accounted for as well (e.g., two mp3 files of a substantially identical song or having substantially identical titles).

According to some aspects, parsing component 204 can also audit the electronic media to determine integrity of such media. Particularly, the files can be examined for unreadable digital bits or related problems with a digital reproduction known in the art, and a quality factor generated based on the audit and associated with each media file. Acceptance of media for integration into the trust can be conditioned on such media receiving a quality factor above a threshold from the parsing component 204. Alternatively, or in addition, withdrawal credit accorded to a submitting entity (e.g., a concurrent participation factor, input factor, etc.) can be adjusted based on the quality factor. Such a mechanism can motivate entities to submit and/or return media in good form, for instance.

Upon parsing a received set of electronic media, and optionally upon auditing such media, parsing component 204 can generate an input participation factor and assign such factor to an entity (or, e.g., to an electronic or other ID associated with such entity) submitting the set. The input participation factor can form a basis for a concurrent participation factor utilized to determine whether an entity can withdraw a particular media element from a media trust as described herein. Once the set of electronic media is parsed and optionally audited, results can be sent to media allocation component 202 along with the input participation factor and ID of a submitting entity.

Media allocation component 202 can receive the results of the parse/audit and maintain a catalogue of media items (e.g., including number and type of individual items) contained within a superset of media owned by a media trust, as described herein. A participant of the trust can submit a request for one or more media items to the media allocation component 202. Media allocation component 202 can receive the request and compare a participation factor of a requesting entity with a combined participation factor associated with the requested media items, and approve or deny the request.

In addition to the foregoing, the media allocation component 202 can include a participation compiler that determines a concurrent participation factor of a requesting entity based at least in part on an input participation factor and a media expenditure factor of the first entity. The input participation factor can be based on all past media items submitted to the trust (including withdrawn items returned to the trust), identified by parsing component 204, and the media expenditure factor can be based on all past media items withdrawn from the trust. More specifically, a media usage component 208 can track a number and/or type of items withdrawn from the trust by an entity, and optionally frequency and/or duration of withdrawal, and generate the media expenditure factor of the first entity there from. Accordingly, an entity's withdrawal privileges can be based in part on a compilation of what the entity has submitted to the commonly owned trust, and what the entity has taken out in the past.

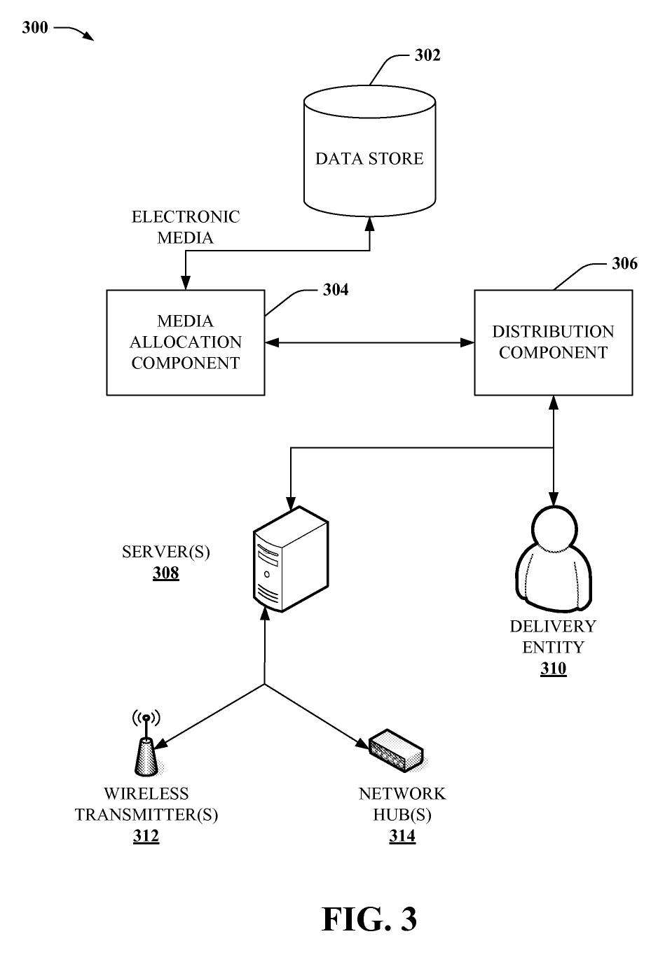

FIG. 3 illustrates a block diagram of a sample system 300 that can distribute output trust-owned media elements to requesting entities. A superset of media contained in a data store 302 can be accessed, reviewed and/or browsed by a participant of such trust. A request for an item(s) can be submitted to a media allocation component 304, which can approve or deny the request, as described herein (e.g., upon comparison of a concurrent participation factor with a predetermined threshold participation factor associated with the item(s)). In addition, system 300 can include a distribution component 306 that can output possession of a hardcopy or provide an electronic copy, or both, of a media element to the participant if the request is approved. Accordingly, possession of items can be transferred to individual participants of the trust, and a media expenditure factor (and concurrent participation factor) of such participants can be updated accordingly.

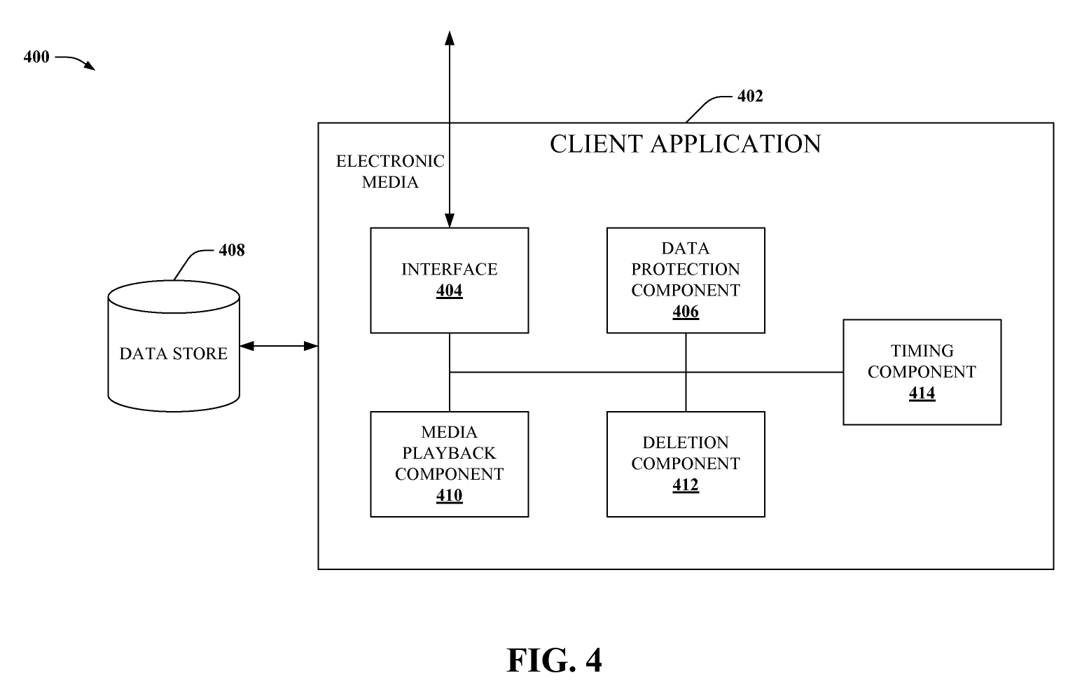

The distribution component 306 can include and/or be interfaced with a remote communication network (308, 312, 314) that transmits an electronic copy of the media element to a communication device of a requesting participant. The communication device can be coupled to the network (308, 312, 314), for instance, by way of an Internet Protocol (IP) connection, or the like. Specifically, a distribution server 308 can receive the electronic copy and provide an IP-type interface to the Internet, or similar IP-type interface. The network can include a wireless component (312), that can include a radio access network of a mobile communication architecture, a wireless local area network (WLAN) transmitter, wireless wide area network (WWAN), or the like. In addition, the network (308, 312, 314) can include a network hub 314 that provides a wireline interface to the server 308. Communication devices, such as a computer or mobile device, can interface with the network server 308 via the wireless transmitter(s) 312 and/or network hub 314, as known in the art. According to additional aspects, distribution component 306 can condition submitting the electronic copy on existence of a client application incorporating DRM on the communication device (e.g., see FIG. 4, infra).

In addition to the foregoing, distribution component 306 can output a hardcopy of digital media to a participant of the commonly owned trust. For instance, the distribution component 306 can receive a hardware copy of digital media from data store 302 (e.g., wherein part of the data store includes a repository for hardware media) and provide the hardware copy to a hardware distribution entity 310 (e.g., a post office, courier, or package delivery service, or the like). Such entity 310 can deliver physical possession of the hardcopy media to a physical address of a requesting entity. According to some embodiments, transfer of physical possession can optionally be conditioned on an agreement by the requesting entity to return the hardcopy to the trust.

FIG. 4 illustrates a block diagram of a sample system 400 that incorporates DRM technology into a client device to protect copyrights in electronic copies of digital media. System 400 can include a client application 402 that can be provided to and installed in a client device (not depicted). The client device can be any suitable communication processing device such as a mobile communication device (e.g., cell phone), personal computer, laptop, PDA, or the like. Further, the client device can download and/or install the client application 402 to obtain a secure interface to a data store containing digital media (e.g., see data store 106 of FIG. 1, supra).

Client application 402 can include an interface 404 that provides a secure connection to an electronic server of a media trust (not depicted). Interface 404 can provide a unique ID of a user of the device (e.g., username and password, secure electronic signature, or the like) to the electronic server to identify such user. If the unique ID matches an ID associated with a participant of the trust, the user can access a catalogue of available media files stored in the trust. In addition, the interface 404 can submit a request for one or more identified media files stored within the trust, which can be approved or denied as described herein.

In addition to the foregoing, client application 402 can include a data protection component 406 that can receive one or more electronic media files from the electronic server. The files can be saved onto a local data store 408 for playback on the client device, or into temporary memory for presentation of streaming media, for instance. The data file can be stored in a secure manner to mitigate un-permitted access and/or copying of such file. For instance, the media file can be saved with a compiled data file where protocols distinguishing the playable media from other data are stored secretly within the client application 402. Alternatively, or in addition, the media file can be saved in a hidden portion of memory, encrypted or hashed to obfuscate the file, or the like. A playback component 410 can contain rules and/or protocols for decrypting/extracting the media file and playing associated media on the client device. A timing component 412 can optionally track a duration that each media is filed stored at the client device if, for instance, access to trust-owned media is for a limited period of time. Once timing component 412 determines an access period for a particular electronic copy of media has expired, the electronic copy can be returned to the trust and/or a deletion component 414 can delete the electronic copy from the client device. Accordingly, client application 402 can secure electronic copies of media downloaded from a media trust to mitigate un-permitted access and help to protect copyrights associated with such media.

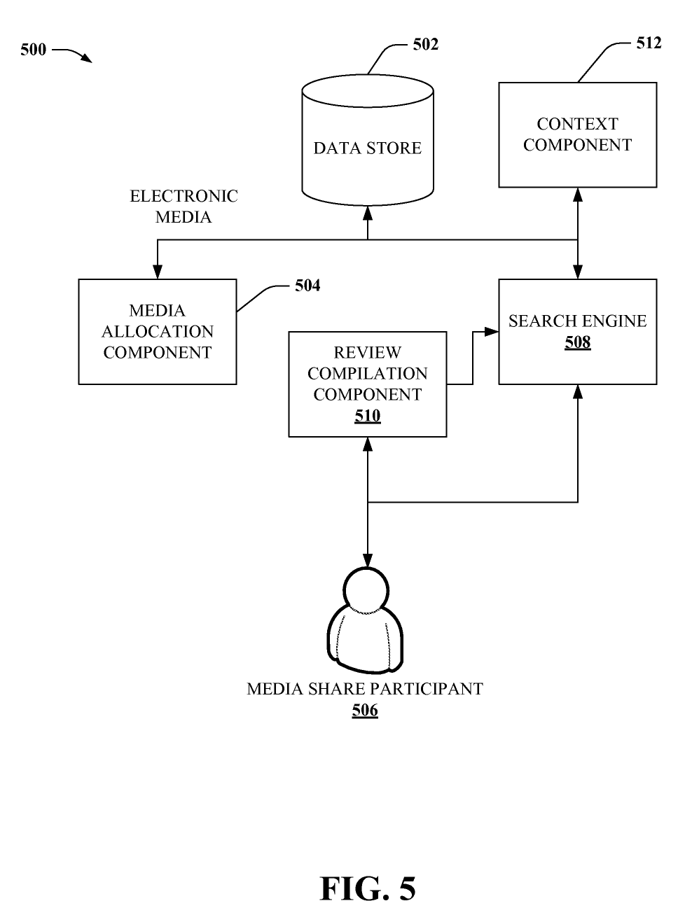

FIG. 5 depicts a block diagram of an example system 500 that can provide social ranking of media files stored in a commonly owned media trust. Such files can be aggregated and stored in a data store 502 associated with the trust as described herein. Further, access to the data store 502 and a catalogue of available titles can be provided by a media allocation component 504 to a trust participant 506. Specifically, such component (504) can include a search engine 508 that enables the participant to utilize various filtering criteria to browse media files within the data store. For instance, the search engine can enable the participant to search based on title, genre, media type, author, producer, editor, or any combination thereof or of like data associated with stored media files. Suitable means for filtering electronic files, known in the art, can be incorporated by search engine 508 and/or media allocation component 504.

In addition, system 500 can include a review compilation component 510 that can receive a relative ranking or a description, or both, from the participant 506 pertaining to a media element. A ranking/description can be associated with a media item submitted and/or withdrawn to/from the trust by such participant (506), or can optionally be an independent review not related to a submission or withdrawal. The ranking/description can be aggregated by the review compilation component 510 with other rankings or descriptions provided by other participants to form a dynamic review of the media element. Such review can be provided to a participant upon browsing the media element (e.g., via the search engine 308 discussed above).

According to one or more additional embodiments, review compilation component 510 can assign a weight to a relative ranking or description of a media element based on particular reviews. For instance, if a participant is identified as a trendsetter (e.g., by increase in requests associated with an item recommended by such participant, or as specified by other participants, or the like), or identified as a ‘friend’ or ‘buddy’ of a particular user (506), such ranking/description can be weighted more heavily in an aggregated dynamic review of the media element. Alternatively, or in addition, a separate portion of the dynamic review can be allocated to information provided by one or more friends/buddies. Accordingly, information pertaining to stored media that is likely to be influential on other participants can be presented to such participants upon reviewing and/or browsing a title or catalogue of titles, or the like.

According to some aspects, system 500 can also include a context component 512 that provides a dynamic review associated with a media element to an entity that browses the media element by searching (508) a superset of media maintained at data store 502. For instance, if a search can return a list of one or more media items within the superset based on related search criteria. A returned item can also include a dynamic review of the item, based at least in part on participant review as discussed above, that can be displayed to the entity upon selecting such item. The dynamic review can inform the entity about the title (e.g., provide a short description of the media), provide a compilation of participant rankings, and optionally can distinguish comments/rankings/descriptions provided by identified friends/buddies. Accordingly, contextual information pertaining to the media item can be provided an entity browsing the data store 502 to help such entity select a desired item.

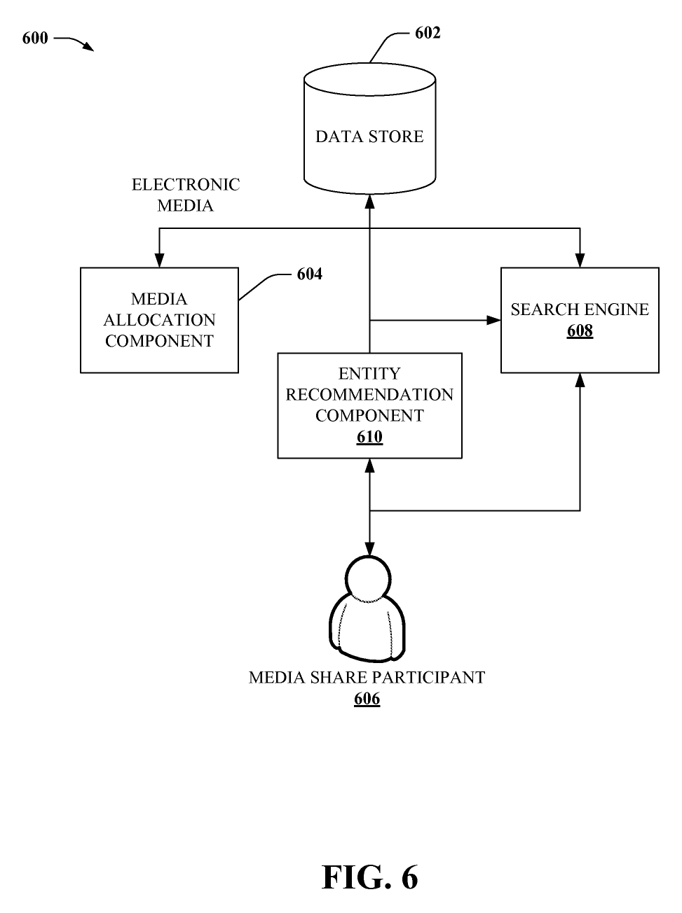

FIG. 6 depicts a block diagram of an example system 600 that can recommend one or more media elements to a participant based on social networking principles. System 600 can include a data store 602 that contains media files commonly owned by a dynamic trust of participants (606), and a media allocation component 604 and search engine 608 providing participants (606) access to such files, as described herein. System 600 can also include an entity recommendation component 610 that utilizes social networking principles to provide recommended media to a participant 606.

Entity recommendation component 610 can track an interaction history of the participant 606 and analyze patterns within such history. For instance, a particular genre or type of media typically requested from the trust (602) can be determined based on such history. In addition, rankings and/or descriptions provided to the trust (e.g., see FIG. 5, supra) by the participant 606 can be incorporated into such patterns as well. Specifically, media titles given a positive ranking can be weighted more highly than titles given a relatively poor ranking by the participant 606, or the like. Also, a preferred media type can be incorporated into a participant recommendation. As an example, if the participant 606 requests DVD movies more often than mp3 audio titles, such history can be incorporated into a recommendation. Such information can be incorporated into a personal media recommendation to a user.

In addition to the foregoing, prior access histories of other participants can also be incorporated into a media recommendation for the participant 606. Participant information can be utilized to provide a correlation between the participant 606 and other such participants. For instance, factors such as age, gender, locale, profession, or a combination thereof or of the like, indicated by such participants can be utilized to categorize participants. Further, participants identified as buddies of participant 606, or who are trendsetters (e.g., based on an indication by participant 606 or based on general feedback and/or history patterns associated with media within data store 602) or the like can be weighted more heavily than other participants. Accordingly, interaction histories based on such participants can be incorporated into a recommendation in a similar fashion as an interaction history of the participant 606, as described above.

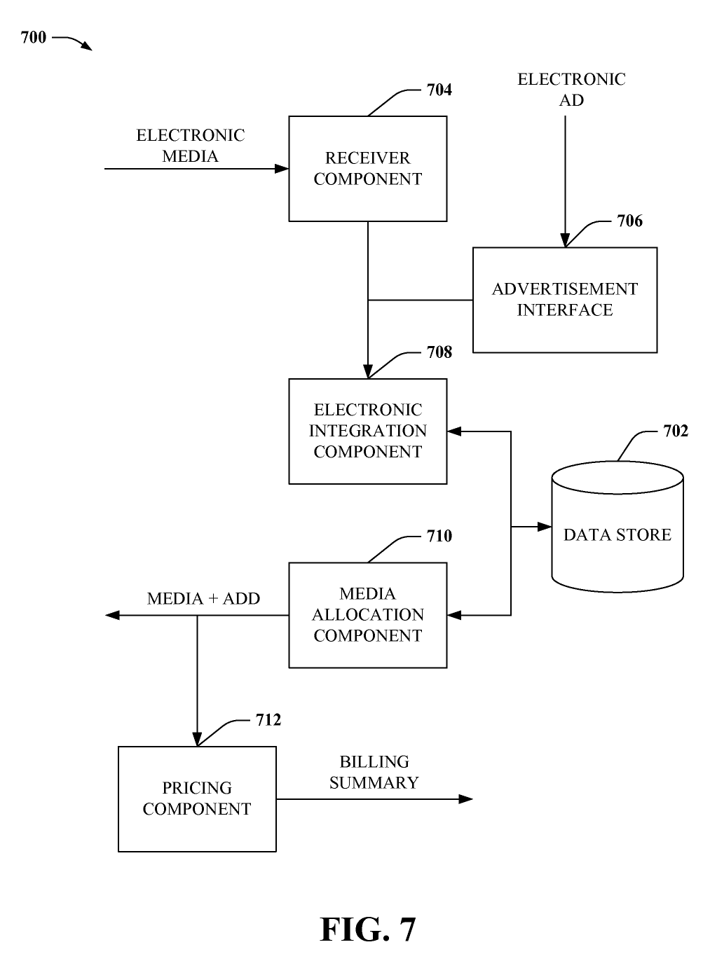

FIG. 7 depicts a block diagram of an example system 700 that can integrate targeted marketing for members of a media trust. For instance, advertisements of external entities into trust-owned media files stored in a data store 702 associated with the trust. In addition, components can search or mine data from stored media to provide discounts, recommended titles, or other marketing information to trust members on behalf of an external entity. For instance, a “frequent buyer” discount can be provided based on a list of titles owned (e.g., a member of the trust owns 100 audio titles from a particular artist, so the discount can be applied to additional titles by that artist at a store, website, etc.). As another example, targeted advertising can be conducted as well. If a member owns 10 DVD movies with a common lead actor, advertisements concerning a new movie featuring the lead actor can be targeted to the user.

Typically, media files stored in data store 702 can be distributed to participants of the trust based on participation with the trust (e.g., a concurrent participation factor as described herein). Such distribution can be cost-free, or can include a nominal fee covering delivery costs (e.g., for delivery of hardware copies), maintenance and support of electronic components associated with the trust store (which, in some embodiments can include components 702, 704, 706, 708, 710, 712), or the like. According to additional embodiments, the trust can generate funds based on distribution of advertising material with media files to defray delivery, maintenance or support costs, or a combination thereof or of like costs. Alternatively, participants who have used up withdrawal rights associated with the trust could optionally still withdraw one or more media files that have advertisements incorporated therein. Distribution of media files in such manner could be contingent, for instance, on agreement to return such files to the trust (e.g., limited to a lease or borrowing arrangement).

System 700 can include a receiver component 704 that can receive and/or parse a set of electronic media as described herein. In addition, system 700 can include an advertisement interface 706 that can receive an electronic advertisement from an external entity. The electronic advertisement can be provided to an electronic integration component 708 that can couple the electronic advertisement with at least one media file of a trust-owned superset of media. For instance, the advertisement can be included within the media file, coupled with it so that playback of the media file will initiate playback of the advertisement, or the like. If a media file coupled to an advertisement is output from data store 708 by a media allocation component 710, as described herein, a pricing component 712 can be updated. The pricing component 712 can charge the external entity a predetermined amount based on dissemination of a media file coupled to the electronic advertisement. Accordingly, system 700 can provide a mechanism to generate value for external entities and capital for the trust, by distributing advertising material with trust-owned media requested by participants of the trust.

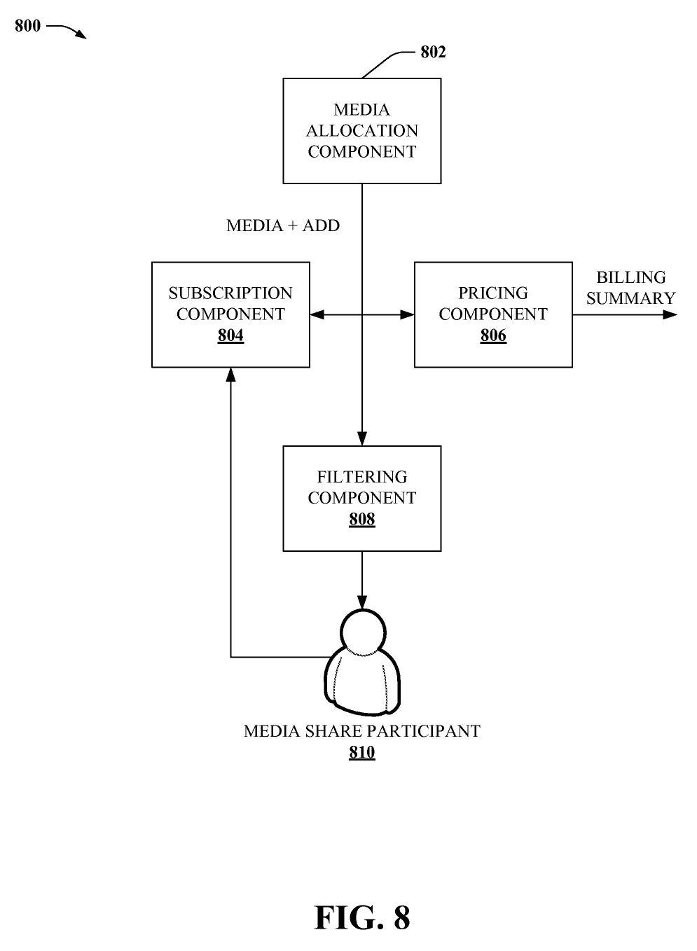

FIG. 8 illustrates a sample system 800 that can remove an electronic advertisement coupled to trust-owned media based on a status of a requesting participant (810) of the trust. Specifically, a media allocation component 802 can distribute one or more requested media files of the trust-owned media as described herein. In addition, the requested media files can be coupled to one or more electronic advertisements as described at FIG. 7, supra. Media allocation component 802 can give a requesting participant 810 a choice as to whether the electronic advertisement should be delivered with the requested media files according to a status of the participant 810.

Participant status can be based on participation with the trust, as described herein. For instance, a subscription component 804 can include a status of a participant 810. The subscription component can receive a unique ID of the participant 810 to determine such status, for instance. Status can be determined based on various suitable alternatives. For example, if a concurrent participation factor associated with the user is sufficient to withdraw the requested media file from the trust, participant status can be approved and participant 810 can be given an option to remove electronic advertisements from the requested media. Alternatively, or in addition, a participant can purchase a right to withdraw (e.g., a limited subscription) a predetermined number of media files from the trust for a predetermined price. Withdrawal could then be in the form of a resale of an output media file from the trust to the requesting entity (806). As another alternative, a non-participant could be provided with an opportunity to purchase the media file from the trust as a resale transaction. If participant status is not current or sufficient to remove the advertisement as defined by rules associated with the trust, media allocation component 802 delivers the media file coupled with the advertisement. It should be appreciated that any of the foregoing alternatives could be incorporated into the definition of status as used herein.

As described, participant 810 can be given an option to remove associated advertisement(s) coupled with a requested media file. Such participant 810 could choose not to remove such advertisement(s), however, to defray delivery or maintenance/support costs associated with participation in the trust. Alternatively, the participant 810 could choose for the advertisement to be removed to provide uninterrupted playback of the requested media file. If media allocation component 802 provides an option to remove advertisement(s), and a participant 810 requests such removal, filtering component 808 strips any electronic advertisement(s) coupled to the requested media. In addition, pricing component 806 is updated and instructed not to charge an external entity supplying the advertisement. Otherwise the advertisement(s) is left intact, and pricing component 806 is instructed to charge the external entity in accordance with a predetermined agreement with such entity. It should be appreciated that any incorporation of advertisement material, or pricing agreements with external entities based thereon, as described herein is subject to copyright limitations, if any, associated with the associated media files.

The aforementioned systems have been described with respect to interaction between several components. It should be appreciated that such systems and components can include those components or sub-components specified therein, some of the specified components or sub-components, and/or additional components. For example, a system could include aggregation component 104, media allocation component 108, data store 106, and input parsing component 204, or a different combination of these and other components. Sub-components could also be implemented as components communicatively coupled to other components rather than included within parent components. Additionally, it should be noted that one or more components may be combined into a single component providing aggregate functionality. For instance, media usage component 206 can include participation component 206, or vice versa, to facilitate generating a media expenditure factor and updating a concurrent participation factor by way of a single component. The components may also interact with one or more other components not specifically described herein but known by those of skill in the art.

Furthermore, as will be appreciated, various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, and in addition to that already described herein, can automate certain mechanisms or processes performed thereby to make portions of the systems and methods more adaptive as well as efficient and intelligent.

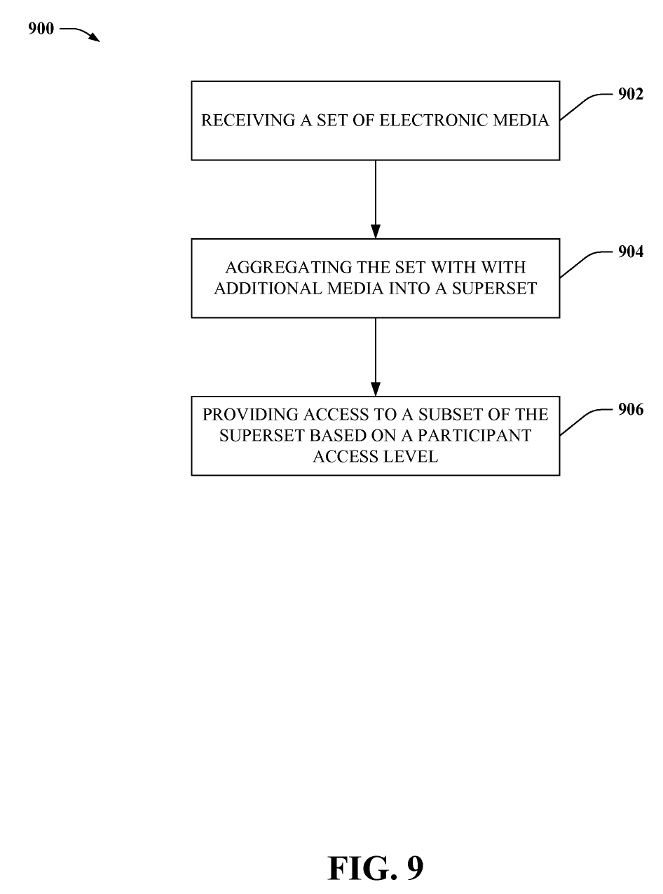

In view of the exemplary systems described sura, methodologies that may be implemented in accordance with the disclosed subject matter will be better appreciated with reference to the flow charts of FIGS. 9-12. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, carrier, or media.

FIG. 9 illustrates a flowchart of an example methodology 900 for receiving, aggregating, and distributing trust-owned digital media according to one or more aspects of the subject disclosure. Method 900, at 902, can receive a set of electronic media. The set can include various suitable types of media (e.g., movies, audio tracks, video games, literary e-Books, educational/exam preparation material, or the like), one or more individual titles (e.g., movies, songs, books), and hardware or software copies of such titles, or both. For instance, a set of electronic media can include five DVD movies as well as a digital file submitted via the Internet that contains five CD albums and five video games. A submitting entity can be identified along with the set of electronic media. Such entity can be identified by a username/password, electronic signature, name and contact information (e.g., phone number, mailing address) or the like.

At 904, method 900 can aggregate the received set of electronic media into a superset of electronic media. Descriptive data associated with individual titles of the superset can be compiled into a catalogue identifying the individual titles and, for instance, genre, author, editor, producer, or a combination thereof or of like information. The catalogue can also indicate a number of available copies of such titles stored within the superset, and provide a searchable mechanism to identify titles based on suitable search criteria, as described herein or known in the art.

At 906, method 900 can provide access to a subset of the superset based on participant access level. Participant access level can be based, at least in part, on number, type, and/or demand of items submitted in the set of electronic media. For instance, if an entity submits 10 DVD titles, the entity might be given an access level sufficient to withdraw 10 DVD titles. Alternatively, or in addition, such submission might entitle the entity to withdraw 10 video games, or a fraction thereof. Also, a participation level could be modified based on a concurrent demand for a submitted title. For instance, if a submitted title is in relatively high demand (e.g., based on a number of requests for the item, participant rating/description of the item as described herein, and so on), the participation level attributed to a submitting entity could be increased. In addition, if a submitted title is in relatively low demand, the participation level attributed to the submitting entity could be decreased.

An entity can request access to a media title, and if the participant access level associated with such entity is greater than an amount required to withdraw an available copy of the media title, then the copy can be output to the entity. An output copy is no longer available for access/output from the superset. Thus, if only a single copy of a particular title is available within the superset, and such title is output as described, the title will be unavailable for further withdrawal until a copy is returned to the superset (e.g., in a similar manner as described at reference number 904) or another copy is received.

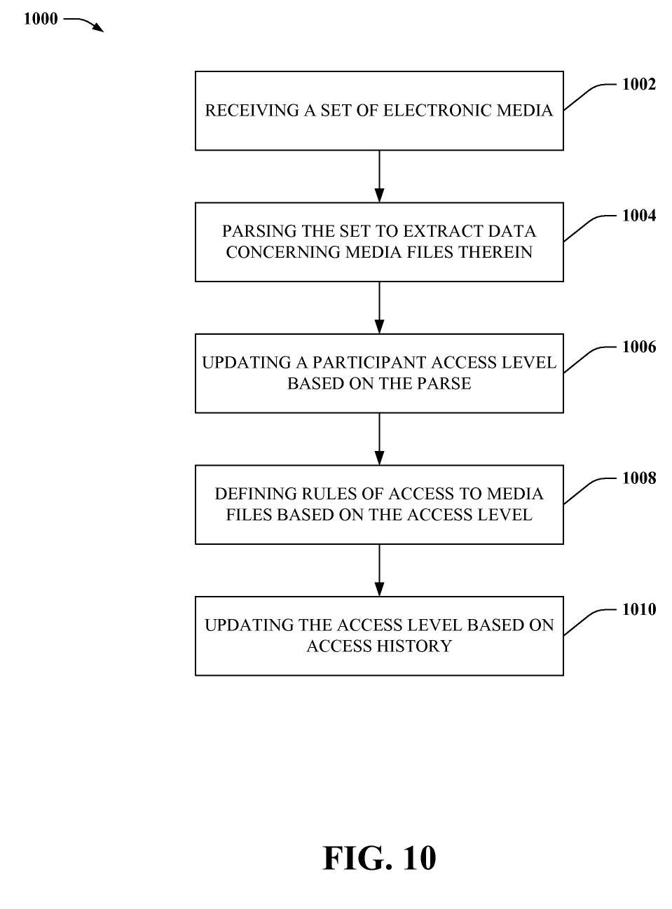

FIG. 10 illustrates a flowchart of a sample methodology 1000 for determining access capabilities of an entity participating in a commonly owned media trust according to particular aspects described herein. At 1002, a set of electronic media can be received as described herein. At 1004, the set can be parsed to extract data pertinent to particular media files contained within the set. Individual media elements can be extracted from the set and identified by title, type, genre, author, editor, and so on, as described herein. Such information can be incorporated into an electronic catalogue describing such elements and a number of available copies (e.g., number of copies submitted minus a number of copies withdrawn). At 1006, a participant access level can be updated based on the parse conducted at reference number 1004. For instance, each media element identified by the parse can increment (or otherwise increase) the participant access level. Incrementing can be modified based on demand of a submitted title, type of media file submitted, and so on. At 1008, rules of access to a superset of media can be defined. For instance, such rules can indicate a number of available media elements that can be withdrawn from the trust based on a number submitted to the trust. Alternatively, the rules can weight various types relative to other types of media. For instance, a DVD movie can be weighted substantially equal to ten mp3 song titles. Thus, as a particular example, submission of one DVD movie can allow withdrawal of up to ten mp3 songs, or vice versa. It should be appreciated that various suitable weights can be utilized to associate one media type with other media types. At 1010, access level of the entity is updated based on access history. Specifically, each withdrawal from the superset reduces the access level a predetermined amount, as described herein. Accordingly, withdrawal privileges from the media trust can be based on a dynamic relation between submitted items (including, e.g., returned items) and withdrawn items associated with the media trust.

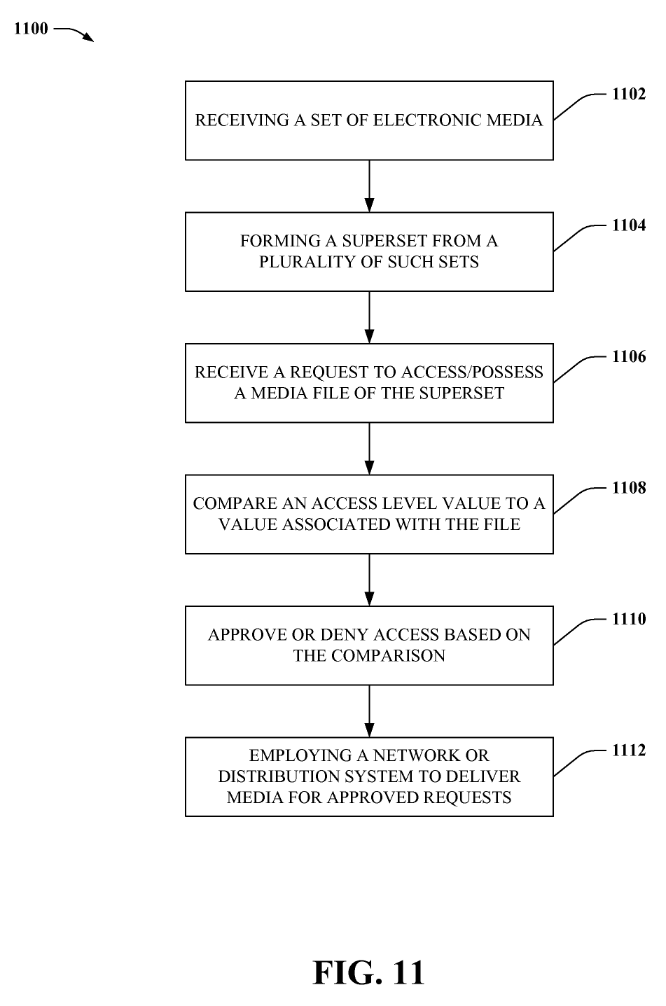

FIG. 11 illustrates a sample methodology 1100 for approving or denying media access requests directed at trust-owned media, and distributing files associated with approved requests to participants of a media trust. At 1102 and 1104, method 1100 can receive a set of electronic media and aggregate the received set with media files from other sets into a superset, respectively, as described herein. At 1106, method 1100 can receive a request to access/possess a media file of the superset. At 1108, an access level of a requester can be compared to a predetermined access level associated with the media file. The predetermined access level can be based on type, ranking, demand, or a combination thereof or of the like, associated with the media file. At 1110, the request can be approved or denied based on the comparison performed at reference number 1108. At 1112, a distribution network and/or delivery system can be employed to distribute media files associated with approved requests. For instance, a distribution network can be utilized to provide electronic copies media files output from the trust. A client device can interface with the distribution network to receive such electronic copies. Alternatively, or in addition, a hardware copy of the media files can be removed from a depository and provided to a delivery entity (e.g., post office, package delivery service, courier, etc.) to be physically delivered to an address of a requesting entity. Accordingly, trust-owned media files can be delivered to requesting entities upon approval to facilitate dissemination of properties owned by the trust to members of such trust.

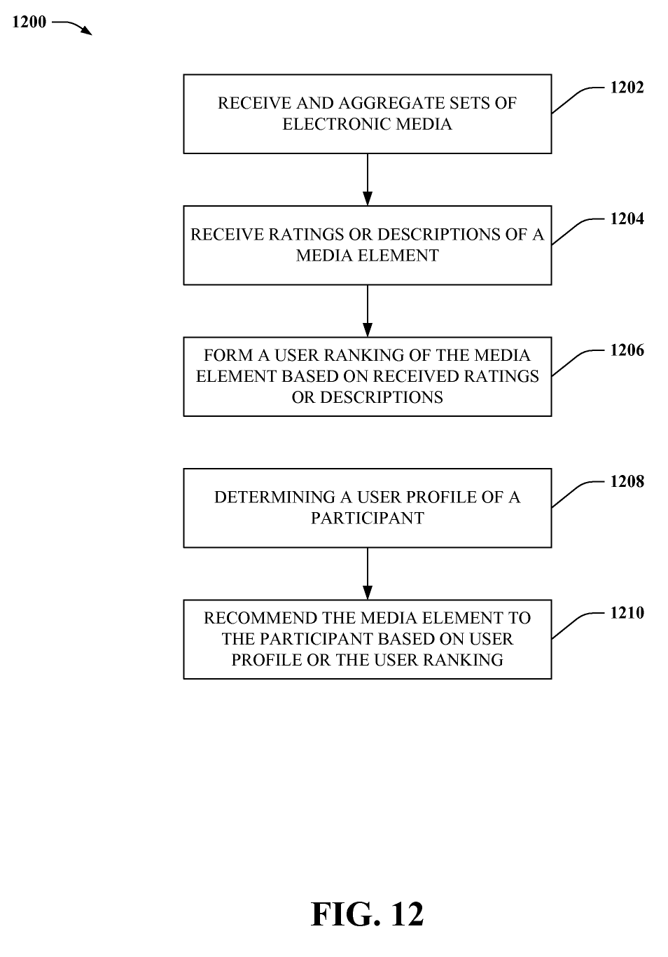

FIG. 12 depicts an example methodology 1200 for ranking and recommending trust-owned media according to one or more aspects of the subject disclosure. At 1202, sets of electronic media can be received and aggregated into a media superset, as described herein. At 1204, a rating or description of one or more media items can be received from participants of the trust. For instance, a submitting entity, viewing entity, or the like can provide a relative ranking (e.g., on a scale of one to ten) for an item(s) to categorize it relative to other items. In addition, such entities can provide a text-based description of the item(s). At 1206, a user ranking can be formed from user feedback of such media element. A compilation of rankings and descriptions can be formed to provide a dynamic summarization of the item(s). The dynamic summarization can include a genre(s), author(s), actor(s), writer(s), editor(s), producer(s), as well as reviewers associated with the item(s). At 1208, a user profile of a participant can be determined. The user profile can indicate a type of media the user prefers, based on interaction history with media elements of the trust (e.g., submitted items, ranked items, withdrawn items, etc.). At 1210, a media element can be recommended to the participant based on the user profile, a user ranking of the media element, or a combination thereof. As described, method 1200 provides a mechanism to inform participants of media elements of the trust that would potentially be of interest to the participant. Accordingly, method 1200 can save time for such participants by proposing recommended elements instead of requiring such participants to generate a search or the like of trust-owned media.

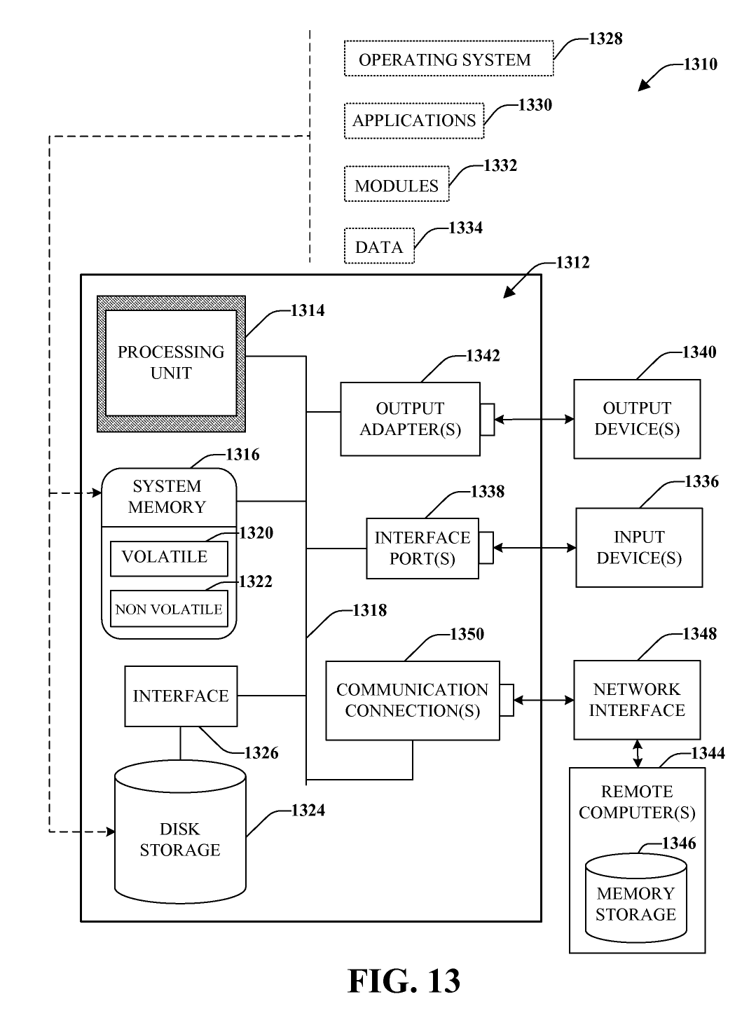

In order to provide additional context for various aspects of the disclosed subject matter, FIGS. 13 and 14 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules.

Generally, program modules include routines, programs, components, data structures, etc. that can perform particular tasks and/or implement particular abstract data types. Such tasks can include receiving, parsing, and/or aggregating digital media associated with a commonly owned media trust, as described herein. Further, relevant tasks can include determining an access level associated with a participant of a media trust and determining access rights to media based on such access level, or other functions of a media trust as described herein. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices, described below.

With reference to FIG. 13, an exemplary environment 1310 for implementing various aspects disclosed herein includes a computer 1312 (e.g., desktop, laptop, server, hand held, programmable consumer or industrial electronics . . . ). The computer 1312 includes a processing unit 1314, a system memory 1316, and a system bus 1318. The system bus 1318 can couple system components including, but not limited to, the system memory 1316 to the processing unit 1314. The processing unit 1314 can be any of various microprocessors, such as dual microprocessors, quad microprocessors, and other multiprocessor architectures suitable for a computer environment 1310.

The system bus 1318 can be any of several types of suitable bus structure(s) including the memory bus or memory controller, a peripheral bus or external bus, and/or a local bus using any suitable variety of available bus architectures including, but not limited to, 13-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable ROM (EEPROM), or flash memory. Volatile memory 1320 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1312 also includes removable/non-removable, volatile/non-volatile computer storage media. FIG. 13 illustrates, for example, disk storage 1324. Disk storage 1324 includes, but is not limited to, devices such as a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to the system bus 1318, a removable or non-removable interface is typically used such as interface 1326.

It is to be appreciated that FIG. 13 describes software that acts as an intermediary between users and the basic computer resources described in operating environment 1310. The software can include various rules for implementing aspects of the subject disclosure, such as determining an access level of a requesting trust participant, approving/denying access requests, submitting media to a requesting entity, incorporating/filtering electronic advertisements, and so on as described herein. Such software can include an operating system 1328. Operating system 1328, which can be stored on disk storage 1324, acts to control and allocate resources of the computer system 1312. System applications 1330 take advantage of the management of resources by operating system 1328 through program modules 1332 and program data 1334 stored either in system memory 1316 or on disk storage 1324. It is to be appreciated that the present invention can be implemented with various operating systems or combinations of operating systems.

A user can enter commands or information into the computer 1312 through input device(s) 1336. Input devices 1336 can include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 can utilize some of the same type of ports as input device(s) 1336. Thus, for example, a USB port may be used to provide input to computer 1312 and to output information from computer 1312 to an output device 1340. Output adapter 1342 is provided to illustrate that there are some output devices 1340 like displays (e.g., flat panel and CRT), speakers, and printers, among other output devices 1340 that require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and can typically include many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems, power modems and DSL modems, ISDN adapters, and Ethernet cards or components.

FIG. 14 is a schematic block diagram of a sample-computing environment 1400 with which the present invention can interact. For instance, the environment 1400 can be suitable to provide a remote interface between one or more client devices and a receiver component, data store, search engine, and/or allocation component associated with a media trust as described herein. The system 1400 includes one or more client(s) 1410. The client(s) 1410 can be hardware and/or software (e.g., threads, processes, computing devices). The system 1400 also includes one or more server(s) 1430. Thus, system 1400 can correspond to a two-tier client server model or a multi-tier model (e.g., client, middle tier server, data server), amongst other models. The server(s) 1430 can also be hardware and/or software (e.g., threads, processes, computing devices). The servers 1430 can house threads to perform transformations by employing the present invention, for example. One possible communication between a client 1410 and a server 1430 may be in the form of a data packet adapted to be transmitted between two or more computer processes.

The system 1400 includes a communication framework 1450 that can be employed to facilitate communications between the client(s) 1410 and the server(s) 1430. The client(s) 1410 are operatively connected to one or more client data store(s) 1460 that can be employed to store information local to the client(s) 1410. Similarly, the server(s) 1430 are operatively connected to one or more server data store(s) 1440 that can be employed to store information local to the servers 1430.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

What is claimed is:

1. A system that facilitates sharing of electronic media, comprising:
a receiver component that receives a set of electronic media associated with a first entity;
an aggregation component that stores the set of electronic media with other sets of electronic media, received from additional entities associated with such other sets, as a superset of media; and
a media allocation component that provides the first entity access to a subset of the superset of media as a function of a concurrent participation factor of the first entity.

2. The system of claim 1, the media allocation component further comprises an input parsing component that at least one of:
categorizes media provided to the receiver component by the first entity, and assigns an input participation factor to the first entity; or
provides a backup, recovery or data transfer service for media provided to the receiver component and associated with the first entity.

3. The system of claim 1, the media allocation component further comprises a media usage component that generates a media expenditure factor for the first entity, the media expenditure factor is a dynamic characteristic based on a number or type of media items of the superset accessed by the first entity, or a frequency or duration of access to the media items, or a combination thereof.

4. The system of claim 1, the media allocation component further comprises a participation compiler that determines the concurrent participation factor based at least in part on an input participation factor and a media expenditure factor of the first entity.

5. The system of claim 1, further comprising a distribution component that outputs possession of a hardcopy or provides an electronic copy, or both, of a media element of the subset to the first entity based on a request for such media element and a comparison of the concurrent participation factor with a predetermined threshold participation factor associated with the media element.

6. The system of claim 5, the distribution component includes a remote communication network that transmits the electronic copy of the media element to a communication device of the first entity that is coupled to the network, or a hardware distribution entity that outputs the hardcopy of the media element for delivery to the first entity for possession, or both.

7. The system of claim 5, outputting possession of the hardcopy is conditioned on an agreement by the first entity to return the hardcopy to the distribution component within a predetermined period of time.

8. The system of claim 5, further comprising a client application made available to the communication device of the first entity, the client application is configured to at least one of:
interface with the communication network to receive the electronic copy;
store a version of the electronic copy at the communication device;
encrypt or hash the stored version to mitigate access to associated source code;
playback media content of the electronic copy; or
delete a locally stored version of the electronic copy upon expiration of a predetermined period of access, or a combination thereof.

9. The system of claim 1, further comprising a review compilation component that:
receives a relative ranking or a description, or both, from the first entity pertaining to a media element of the set of electronic media; and
aggregates the relative ranking or description with other rankings or descriptions of such media element to form a dynamic review of the media element.

10. The system of claim 9, further comprising a context component that provides the dynamic review to an entity that browses the media element by searching the superset.

11. The system of claim 1, further comprising an entity recommendation component that provides a recommendation to the first entity of at least one media element of the superset based at least in part upon:
a genre or type of media contained within the set of electronic media;
a ranking or description of a media element provided by the first entity;
a prior access to media within the superset, or
an access history of another entity that has provided or received media to/from the superset, or a combination thereof.

12. The system of claim 1, further comprising:
an advertisement interface that receives an electronic advertisement from an external entity;
an electronic integration component that couples the electronic advertisement with at least one media file of the superset, the media file is selected based on data mined from the superset of media; and
a pricing component that charges the external entity based on dissemination of the electronic advertisement to the first entity with the at least one media file.

13. The system of claim 12, further comprising at least one of:
a subscription component that receives payment from the first entity for a term-based subscription to media within the superset, or for an item-by-item fee to access the media within the superset; and
a filtering component that removes or disables the electronic advertisement from a version of the at least one media file distributed to the first entity if the item-by-item fee is paid for the at least one media file or if payment for the term-based subscription is current.

14. A method of providing shared electronic media, comprising:
receiving a set of electronic media from a first participant;
aggregating the set of electronic media with additional media to form a superset of media;
providing the first participant with access to a subset of the superset of media based on an access level defined at least in part by contents of the set of electronic media.

15. The method of claim 14, further comprising:
parsing the set of electronic media to identify a number, type, genre, quality, or participant demand, or a combination thereof, of media files contained within the set of electronic media; and
updating the access level at least in part based on the parsed media files of the set of electronic media.

16. The method of claim 14, further comprising:
defining a number of media files in the subset, or a duration or frequency of access to such media files of the subset, based at least in part on the access level; and
updating the access level based at least in part upon:
number, type or demand of such media files distributed to the first participant;
receipt of the media files from the first participant;
duration of use of the media files;
frequency of use of the media files; or
return quality of the media files, or a combination thereof.

17. The method of claim 14, further comprising distributing a hardcopy or an electronic copy to the first participant of a media file contained within the subset, based on a request for the media file and a comparison of a current value of the access level and a predetermined value associated with the media file.

18. The method of claim 17, further comprising employing an electronic communication network to transmit the electronic copy, or employing a distribution entity to deliver the hardcopy, to the first participant.

19. The method of claim 14, further comprising at least one of:
receiving one or more participant ratings or descriptions of a media element within the superset and collating a user recommendation from the ratings or descriptions;
determining a user profile based at least in part on a genre or type of media contained within the set of electronic media and recommending additional media to the first participant consistent with the user profile; and
recommending the media element to the first participant based on the user recommendation or a correlation between the user profile and a genre or type of the medial element, or both.

20. A system that facilitates sharing of electronic media, comprising:
means for receiving a set of electronic media associated with a first entity;
means for storing and aggregating the set of electronic media with other sets of electronic media into a superset of media; and
means for allocating the first entity access to a subset of the superset of media as a function of a concurrent participation factor of the first entity, the concurrent participation factor is based at least in part on:
a number, type or genre of media elements of the set of electronic media;
access history of the first entity to stored media elements of the superset; or
return history of the first entity regarding accessed media elements, or a combination thereof.
